(19) United States
(12) Patent Application Publication
(10) Pub. No.: US 2024/0322660 A1
(43) Pub. Date: Sep. 26, 2024

(54) MULTI ROTOR RADIAL FLUX ARCH STATOR MOTOR

(71) Applicant: George Mathew, Dallas, TX (US)

(72) Inventor: George Mathew, Dallas, TX (US)

(21) Appl. No.: 18/125,377

(22) Filed: Mar. 23, 2023

(51) Int. Cl. H02K 16/00; H02K 1/14; H02K 7/04; H02K 7/10

(52) U.S. Cl. CPC H02K 16/00; H02K 1/14; H02K 7/04; H02K 7/10; H02K 2213/12

(57) ABSTRACT

A multi-rotor radial flux arch stator motor utilizing two or more rotors and one or more stators positioned in between every two adjacent rotors. A plurality of stator windings are wound around the stator cores occupying the space in between the rotors. The stator cores concentrate and direct the flux produced by the stator windings radially to rotors on either side of the stators. The number of stator poles is equal to two times the number of stator windings. The motor design of the invention can be used for both synchronous and asynchronous motor applications. For synchronous applications, a mechanical linkage serves to synchronize the rotors and also transmits torque between rotor shafts if all rotor shafts are not equally loaded. For asynchronous motor applications the motor can be designed without a mechanical linkage between rotors depending on the distribution of the load.

### CROSS REFERENCE TO RELATED APPLICATION

This application claims priority to Provisional Patent Application reference number: 63/393,971, filed, Aug. 1, 2022, which is incorporated herein, in its entirety.

### FIELD OF THE INVENTION

The present invention relates in general to motors used in electric vehicles and other industrial applications. More particularly, the invention relates to an electric motor comprising two or more rotors mounted for rotation on stators having stator cores, with a stator core positioned in between every two adjacent rotors.

### BACKGROUND OF THE INVENTION

Gasoline, the fossil fuel popularly used to run the motor vehicles around the world has contributed to the excessive emission of carbon and other green-house gases, resulting in deleterious effects on our climate. A 2016 study by the Environmental Protection Agency (EPA) attributes 30% of the green-house gas emissions to, the gasoline used in motor vehicles. This has led to an urgency to wean away from gas fueled vehicles to electric vehicles, as heavily emphasized by the current United States administration.

As the popularity and demand for electric vehicles increases in coming years, so too will the need for the motors in these electric vehicles to have higher power densities. The need for motors in electric vehicles to have higher power densities has led to the increasing use of high strength magnets in these motors. Neodymium™ is a key ingredient in the magnets currently used in these motors. However, the extraction and purification of this metal uses toxic chemical compounds which cause severe soil and groundwater pollution across vast regions surrounding the mines excavating this metal. The motor design of the present invention increases the power density of motors to levels acceptable for electric automobile applications, without using high strength magnets. The motor design of the invention has the flexibility to be also used with high strength magnets to generate higher power densities for applications in aerospace which can lead to considerable weight savings in applications such as distributed propulsion.

There is a need to increase the power density of electric motors to levels acceptable for automobile applications without using high strength magnets made of metals that require the use of chemical compounds that pollute the environment. The, motor design of the present invention increases the power density of electric motors to levels acceptable for automobile applications, without using high strength magnets.

The design of the motor of the invention also allows significant reduction in fixed tooling and machinery costs, as well as reduced variable labor costs for motor manufacturing as compared to conventional motor designs, enabling entrepreneurs to compete without large upfront capital investment. The lower fixed cost also allows customization and tailoring of motors to specifications that better suit requirements.

The motor design of the invention allows its use in vehicles having multiple closely-spaced parallel axels such as double axel buses and trucks, earth movers, construction vehicles and multi-axel military vehicles.

A further advantage of the motor design of the present invention is the ease of service of vehicles using the motor. Mechanics trained in repairing vehicles with internal combustion engines can repair vehicles equipped with the motor of the invention with minimal additional training which would allow owners of electric vehicles with the new motor design to use the well-established network of auto repair businesses, and preserve the jobs of those mechanics despite the shift in technology to the new motor design.

The exemplary features and advantages of the motor design of the present invention, will become obvious to one skilled in the art through the following summary of the invention and the detailed description of the invention viewed in conjunction with the drawings of the motor design of the invention.

### SUMMARY OF THE INVENTION

The present invention is a multi-rotor radial flux arch stator motor for use in electric vehicles and other industrial applications without the use of high strength magnets.

In the exemplary embodiment of the present invention, the electric motor consists of two or more rotors mounted for rotation alongside stator cores, with a plurality of stator cores positioned in between every two adjacent rotors. In this embodiment, unlike the conventional single rotor motor designs, where the stator pole of the motor is a single unit made up of a stack of circular laminations with the stator pole profiles cut into them, the stator cores of the present invention are positioned and shared between two rotors, with each stator winding and stator core being individual parts in the motor assembly. Both ends of each stator core act as the magnetic poles around the rotor and this enables the flux at both ends of the stator core to be converted to torque, more efficiently. The stator windings for different phases are arranged sequentially around the rotors depending on the number of phases. Further, the stator design enables higher flux density at the face of the stator pole up to the saturation point of the core material due to the uniform cross-sectional area of the stator core both at the pole face and at the stator windings. In this embodiment of the motor, an arch stator eliminates the need for gaps between stator poles because the stator windings are not inserted into slots around the rotor as in conventional motors. This design of the motor, lowers torque ripple in synchronous applications due to the negligible gap between stator poles.

The design of the motor simplifies the process of winding electrical conductors around the stator core thereby reducing the need for sophisticated machinery and skilled labor for fabrication, and increasing reparability if repairs such as replacing stator windings or stator cores are required.

In the embodiments of the invention, the stator windings are wound around the stator core by spinning the stator core, and reeling electrical conductors onto the stator core before the stator cores are assembled. The design of the motor allows for easier cooling of the stator windings due to their position away from the rotors. The position of the stator core windings away from the rotors makes it possible to cool the windings by liquid immersion or by air cooling, enabling higher current flow and improved flux linkage.

The motor design of the invention can be used for both synchronous and asynchronous motor applications. For synchronous applications, a mechanical linkage keeps the multiple rotors in sync. The mechanical linkage also transmits torque between rotor shafts if all rotor shafts are not equally loaded. For asynchronous motor applications this design can be used with or without a mechanical linkage between rotors depending on whether equal levels of speed and torque are desired at each rotor for the application.

For applications where one or more rotors may be driven as a generator by a mechanical power source while other rotors drive loads as a motor, the mechanical linkage can either be eliminated or even used with a clutch to selectively engage the mechanical linkage to transmit power directly from the mechanical power source to the driven rotors, bypassing the motor, or even to work in conjunction with the motor using an external electrical power source to drive the rotors in addition to the mechanical power source.

The electric motor of the present invention helps to reduce flux linkage loss and weight especially in applications where high power-density is required and where having multiple parallel rotary power sources is advantageous

The motor design of the invention allows for stator laminations to be oriented either perpendicular to the axis of rotation of the rotors, or such that the lamination edge at the pole face runs parallel to the axis of rotation. If the latter orientation is used, laminations can be produced as rectangular strips using simpler machinery and tooling while lowering the amount of scrap generated in the process due to the reduced complexity of the shape of the stator laminations as compared to circular stator laminations made using a stamping process.

The modular design of the motor simplifies customization of the motor without drastic redesign as motors of different configurations and power outputs can be built using common parts without the additional fixed cost of tooling such as the cost of new dies for stamping laminations, molds for casting body casings, and the use of end caps of various sizes.

The motor design of the invention can be used in applications involving supplementing or transmitting rotational power as one or more of the rotors can function as a generator when connected to a rotary power source while the remaining rotors function as motors driving loads. The stator windings may be shorted or used to supplement the power from an external electrical power source to drive a load.

### BRIEF DESCRIPTION OF THE DRAWINGS

FIG. 1 is an isometric view of the arch stator motor of the invention with the right front end cap disassembled.

FIG. 2 is an isometric view of an individual stator core of the invention with the stator windings.

FIG. 3 is a plan view of the phase connections for a dual rotor switched reluctance type motor of the invention.

FIG. 4 is a plan view of the phase connections for a multi rotor switched reluctance type motor of the invention.

FIG. 5 is a plan view of the magnetic circuit showing the polarities of a phase during activation, and the direction of the rotation of the rotors.

FIG. 6 is an isometric view of the alternate orientation of the laminates in the stator cores.

FIG. 7 is an isometric view of the motor of the invention showing a mechanical linkage between the rotors.

FIG. 8 is a plan view showing the types of stator cores.

### DETAILED DESCRIPTION OF THE INVENTION

The present invention is a multi-rotor radial flux arch stator motor with a high power-density for use in electric vehicles and industrial applications. The design of the motor eliminates the need for using high strength magnets to achieve higher power-density.

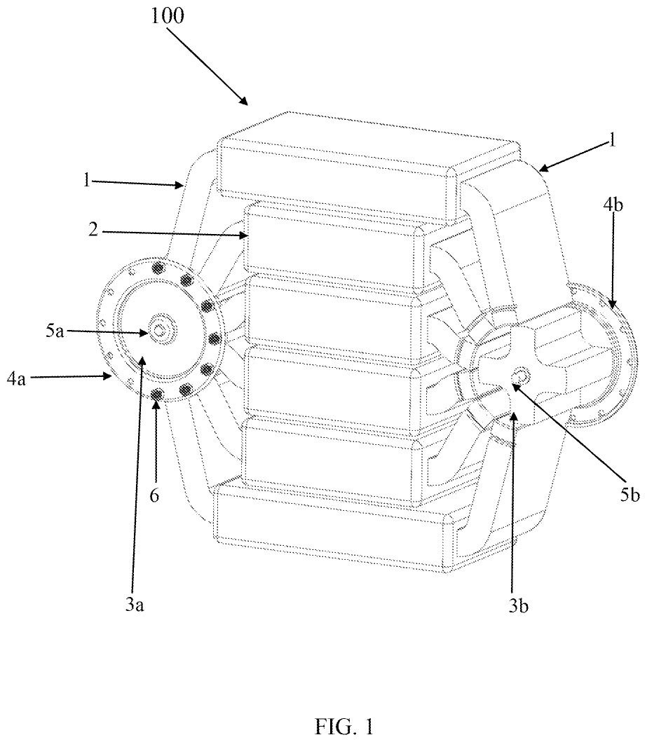

Referring now to the drawings wherein like numerals represent like components of the motor of the invention in the several views presented and discussed, and more particularly referring now to FIG. 1, the figure is an isometric view of the arch stator motor 100 of the present invention. Each stator core 1 of the arch stator motor 100 serves to concentrate the magnetic flux linking the rotor 3 and the stator windings 2 as is the case with any electrical machine. In conventional single rotor motor designs, the stator poles of the motor are a single unit made up of a stack of circular laminations with the stator pole profiles cut into them. In the motor design of the present invention, the stator core 1 is positioned and shared between two rotors 3a (positioned behind endcap 4a) and 3b as seen in this view of the arch stator motor 100 and each stator winding 2 and stator core 1 are individual parts in the arch stator motor 100 assembly. Both ends of each stator core 1 act as the magnetic poles around the rotors 3a and 3b, and this enables the flux at both ends of the stator core 1 to be converted to torque more efficiently. The rotors 3a and 3b are held in their axes of rotation by end caps 4a and 4b. The end caps 4a and 4b hold the rotor bearings to support the rotor shafts 5a and 5b and locks the entire assembly through fasteners 6. The end caps serve to support the stator armature cores in their positions around the rotors as well. The end caps must be electrically insulated from the stator armature cores in order to minimize eddy current losses. The end caps could also be designed to support the mechanical linkage between the rotors and the rotor position sensors for synchronous applications. The stator windings 2 are wound onto the stator cores 1. The stator cores 1 with windings 2 for different phases are arranged sequentially around the rotors depending on the number of phases. The position of the stator windings away from the rotors makes it possible to cool the windings by liquid immersion or by air cooling. The gap between the stator windings can be increased to enable higher volume of coolant flow and the length of the wound region can be increased to provide a larger surface area for cooling. This will enable better thermal control and higher current flow through the windings.

The multiple rotors of a motor of this design may or may not be identical in size and type. In applications such as hybrid drives for example, a permanent magnet rotor can be used for the rotor driven by the rotary power source, while a squirrel cage rotor may be used for the rotor to which the load is connected. During normal operation as a motor, adjacent rotors will have opposing directions of rotation. For asynchronous machines and hybrid drives, each rotor may differ in type and size depending on the application, and each rotor may have different levels of speed and torque depending on the load on the rotor and different levels of power depending on the configuration of the motor, where the maximum power output of a rotor depends on the number of stator poles surrounding the rotor.

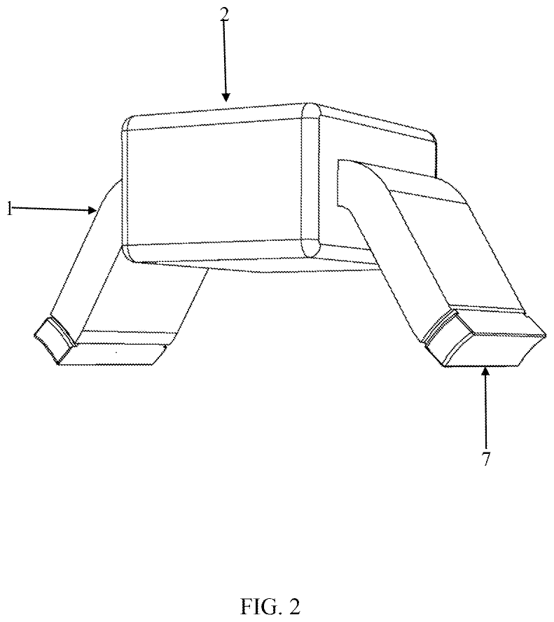

FIG. 2 shows an example of an individual stator core 1 with a stator winding 2 and the pole face 7 of the stator core. Each stator core 1 is an individual part, and the stator winding 2 is wound around the stator core 1 by simply reeling the stator winding 2 onto the stator core 1 before the stator cores are assembled. This makes the winding process a lot simpler as it could be done quickly and easily using a simple spinning apparatus. This process is simpler as compared to the process of inserting pre-wound stator windings into slots requiring complex machines or highly skilled labor for manufacturing of conventional motors with stator pole profiles stamped into the stator laminates. Besides fabrication, replacing damaged stator windings could also be done relatively easily due to the design. It will involve removing just the core with the damaged windings, and rewinding the old core, or replacing it with a new core with windings. Each stator armature core has two poles and is shared between two adjacent rotors with each pole facing one rotor.

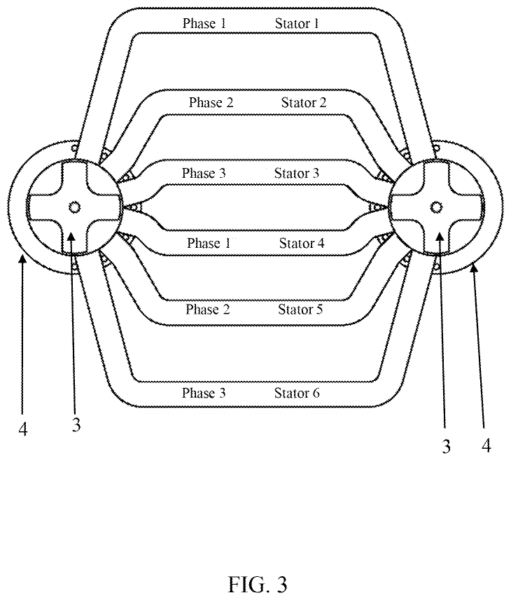

FIG. 3 is a plan view of the phase connections for a dual rotor switched reluctance type motor of the invention. The figure depicts a twelve pole, dual rotor switched reluctance motor with six stator windings. The motor has 3 phases consisting of 2 stator windings per phase. In this design, the phases are, Phase 1 (Stator 1 and 4), Phase 2 (Stator 2 and 5) and Phase 3 (Stator 3 and 6) where the stators are numbered one to six from top to bottom. The magnetic circuit of Phase 1 and Phase 3 will be equal as they are made up of stators of equal sizes. Phase 2 consists of two identical stators of length longer than the two inner-most stators and shorter than the two outer-most stators.

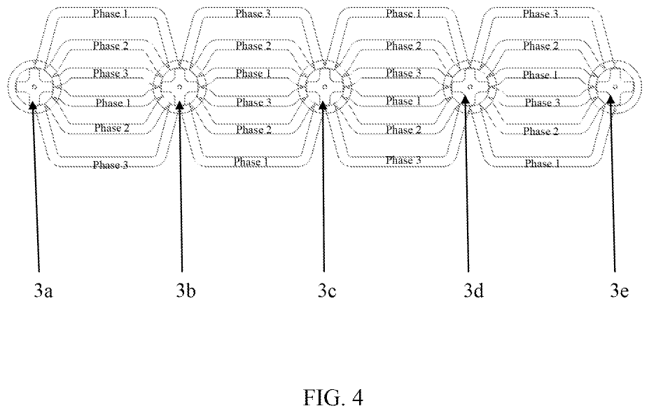

FIG. 4 is a plan view of the phase connections for a multi rotor switched reluctance type motor of the invention. The figure shows the phases of an arch stator motor with more than two rotors. During normal operation, the two stator cores in a phase and the two rotors form a magnetic loop when the poles of the rotors tend to align to the activated stator poles.

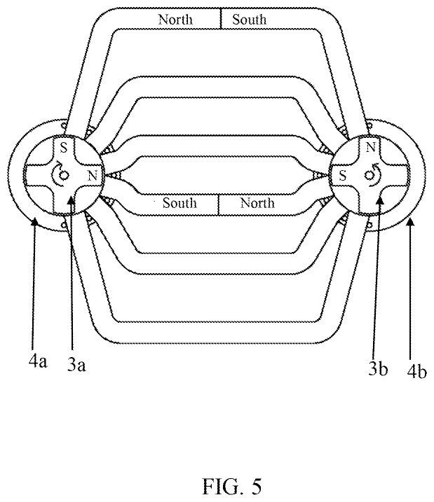

FIG. 5 is a plan view of the magnetic circuit showing the polarities of a phase during activation, and the direction of the rotation of the rotors. The figure shows the magnetic polarity of the stator poles due to activation of the stator windings, the induced polarity of the rotor poles and the resulting direction of rotation of the rotors for a switched reluctance machine.

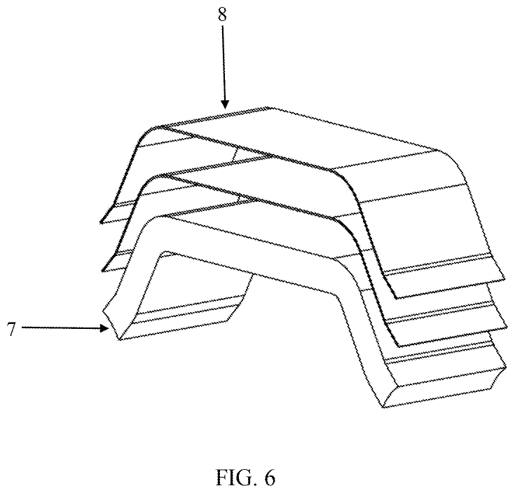

FIG. 6 is an isometric view of an alternative way of orienting the stator laminates to build the stator cores of the motor. The individual stator cores are made of stacked rectangular laminates 8 which are bent to the required stator profile, The stator cores could also be made by stacking the laminates 8 perpendicular to the axis of the rotors as in conventional motor designs, without the benefit of lower tooling cost and scrap as this will require the laminates to be cut to the unique shape of the stator profile. The laminates 8 can be oriented such that the laminate edge facing the cylindrical surface of the rotor at the stator pole is parallel to the axis of rotation of the rotor. This is unlike conventional design in which the laminates lie in a plane perpendicular to the axis of rotation. This allows the stator cores to be made up of stacks of rectangular laminates rather than complex circular profiles. As a result, the need for extensive machinery and dyes for stamping laminates are eliminated. The amount of scrap generated is also reduced significantly due to the rectangular shape of the laminates, thereby reducing the overall material and machinery cost. This allows the motor specifications to be customized without the steep initial fixed costs associated with tooling. However, the stator cores could also be made up of laminates stacked in the plane perpendicular to the axis of rotation or as a combination of both in order to increase the rigidity of the stator cores. If a combination of laminates, with pole edges perpendicular and parallel to the axis of rotation, is used, care must be taken to ensure that parallel laminates are never sandwiched between perpendicular laminates in order to prevent eddy currents. The stator core is made up of laminates of material having high magnetic permeability to reduce hysteresis and eddy current losses as in conventional machines.

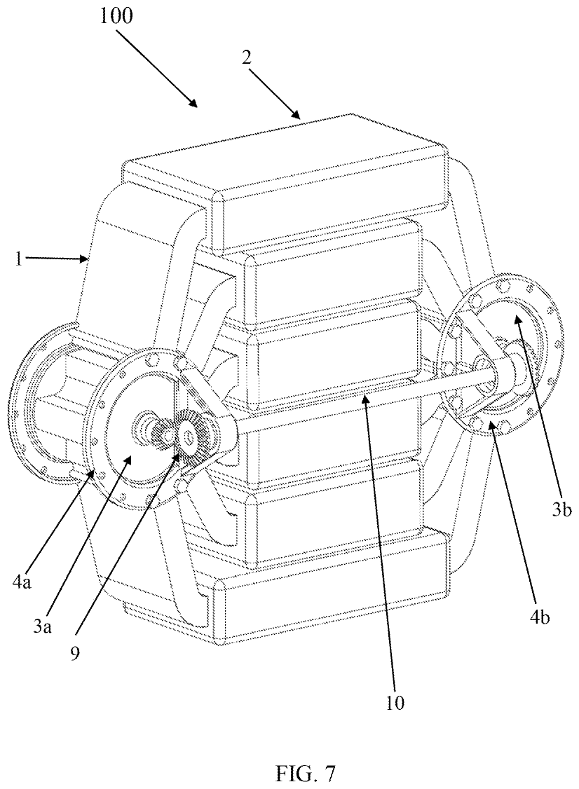

FIG. 7 is an isometric view of an arch stator motor 100 showing the mechanical linkage between the rotors 3a and 3b. For synchronous applications, all rotors of the machine need to be at the same relative position with respect to the stators 1 as the stators are shared between rotors. The mechanical linkage serves the purpose of keeping the rotors in sync. As illustration, four bevel gears 9 and the mechanical linkage shaft 10 are used in the motor shown in FIG. 7. However, any other form of linkage may be used in its place depending on what best suits the application. The activation of a stator winding 2 should result in the same degree of rotation of all rotors in order for them to rotate in sync at the same angular velocity. The mechanical linkage also enables transmission of mechanical power between rotors, and the output of the motor could be at any one or at multiple rotors, or at some part of the mechanical linkage. The dimensions of the rotor shafts and the elements of the mechanical linkage can be calculated based on the selection of the output shaft as this determines the amount of torque and power each component needs to transmit. Further, a clutch mechanism to selectively engage or disengage the mechanical linkage between the rotors can be used, allowing the motor to switch between synchronous and asynchronous operations. This can be used in applications such as transmissions for hybrid vehicles. The motor design of the invention when used with asynchronous drives in automobiles having coaxial wheels, can eliminate the need for a mechanical differential as each wheel will be driven by one rotor which independently varies its speed and torque.

As is the case with most brushless synchronous machines, some form of position sensing is required for synchronous applications. The position sensors used in the design of the motor of the invention, have no difference in design or function from those used in conventional synchronous motor designs. Although adjacent rotors will have opposite directions of rotation, the position of all rotors of the motor are related, and can be determined using just a single position sensor despite the motor having multiple rotors. The sensor could be mounted on a rotor or even on a rotating component of the mechanical linkage.

In embodiments of the motor design of the invention, the rotors and stator cores are enclosed in a casing. The purpose of the rotor and stator core casing is to create a protective enclosure around the rotors and stator armature windings. Additionally, the casing provides additional mechanical strength to the motor to withstand bending and torsional forces which tend to deform the motor when the motor is under load. If the motor is to be liquid-cooled, the casing around the stator is designed to be liquid-tight and hold coolant to cool the windings by liquid immersion. The casing can have inlets and outlets for the coolant if it is circulated through an external radiator. The casing can also be designed to support the mechanical linkage and position sensors.

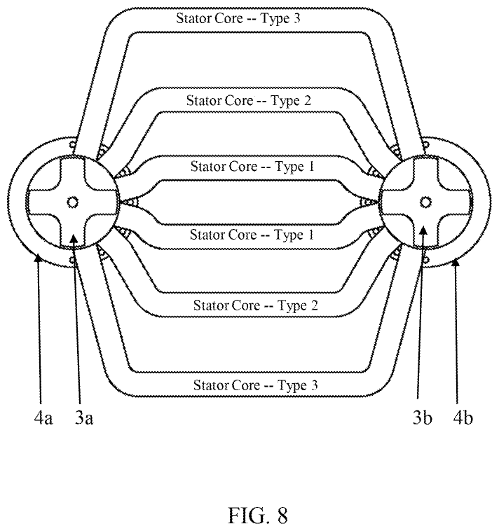

FIG. 8 is a plan view showing the types of stator cores.

Although FIG. 1, FIG. 2 and FIG. 7 only show windings at the center of the stator cores for simplicity, the entire length of the stator core may be wound in order to maximize the power density of the motor.

Following is a detailed description of the mathematical model used to determine the optimal stator dimensions for the motor/generator shown in FIG. 1 and FIG. 7.

### Mathematical Model for Optimization of Stator Dimensions

Using input parameters such rotor radius, power requirement and input voltage, the cores of the motor/generator shown in FIG. 1 and FIG. 7 were designed by varying the length and shape of the stator cores based on the following key objectives:
Ensure that the required number of turns can be accommodated in the space between the stator cores
Minimize the overall core length of all cores and thereby minimize the total volume of the motor/generator and the amount of core material used
Maximize the flux density of each magnetic circuit up to the saturation of the core material in order to maximize torque on the rotor
Minimize the difference in flux density between each magnetic circuit
Minimize the difference in number of turns between each stator.

The optimal dimensions for the stator cores were obtained using nonlinear optimization function based on the mathematical model for the core dimensions and the input parameters.

### Approach Used for Estimating Stator Dimensions

Inputs: The following variables are used by the solver while optimizing the outputs to reach the maximum value of the objective function:
Radius R of the rotors
Power output P of the motor
Input voltage V of the power source used
Saturation S point of the core material
Bend radius B of the bends in the stator cores

Output: The following dimensional variables can be altered by the solver in order to reach the optimal value of the objective function:
Length L is the perpendicular distance between two axes of the rotors
R₁, R₂ and R₃ are the lengths the stator cores of types 1, 2 and 3 (refer FIG. 8) extend from the rotor before bending and running parallel to the plane containing the rotor axes
Angles x and y are the angles by which stators of type 1 and 2 are bent towards the vertical

The Wound Length (length of stator core covered by windings) of stator cores of type 1, 2 and 3 (refer FIG. 8), S1_{WL}, S2_{WL} and S3_{WL} respectively, can be determined using the following equations:

$$S {1}_{WL} = L - 2 ( Rcos 15 + 2 Bsin \frac{x}{2} cos ( 15 + \frac{x}{2} ) + {R}_{1} cos ( 15 + x ) + 2 Bsin \frac{15 + x}{2} cos \frac{15 + x}{2} ) \qquad ( 1 )$$

$$S {2}_{WL} = L - 2 ( Rcos 45 + 2 Bsin \frac{x}{2} cos ( 45 + \frac{x}{2} ) + {R}_{2} cos ( 45 + y ) + 2 Bsin \frac{45 + y}{2} cos \frac{45 + y}{2} ) \qquad ( 2 )$$

$$S {3}_{WL} = L - 2 ( Rcos 75 + {R}_{3} cos 75 + 2 Bsin \frac{75}{2} cos \frac{75}{2} ) \qquad ( 3 )$$

The Wound Height (height from stator core surface to the outer most level of stator windings) of stator cores of type 1, 2 and 3 (refer FIG. 8), S1_{WH}, S2_{WH} and S3_{WH} respectively, can be determined using the following equations where T is the thickness of the stator core:

$$S {1}_{WH} = Rsin 15 + 2 Bsin \frac{x}{2} sin ( 15 + \frac{x}{2} ) + {R}_{1} sin ( 15 + x ) + 2 {Bsin}^{2} ( \frac{15 + x}{2} ) - 0.5 T \qquad ( 4 )$$

$$S {2}_{WH} = Rsin 45 + 2 Bsin \frac{y}{2} sin ( 45 + \frac{y}{2} ) + {R}_{2} sin ( 45 + y ) + 2 {Bsin}^{2} ( \frac{45 + x}{2} ) - 1.5 T - 2 S {1}_{WH} \qquad ( 5 )$$

$$S {3}_{WH} = ( R + {R}_{3} ) sin 75 + 2 Bsin ( \frac{75}{2} ) - 2.5 T - 2 ( S {1}_{WH} + S {2}_{WH} ) \qquad ( 6 )$$

The Core Length (length of laminations from one pole face to the other) of stator cores of type 1, 2 and 3 (refer FIG. 8), S1_{CL}, S2_{CL} and S3_{CL} respectively, can be determined using the following equations:

$$S {1}_{CL} = 2 ( 2 π B \frac{x}{360} + {R}_{1} + 2 π B \frac{( x + 15 )}{360} ) + S {1}_{WL} \qquad ( 7 )$$

$$S {2}_{CL} = 2 ( 2 π B \frac{y}{360} + {R}_{2} + 2 π B \frac{( y + 15 )}{360} ) + S {2}_{WL} \qquad ( 8 )$$

$$S {3}_{CL} = 2 ( {R}_{3} + 2 π B \frac{75}{360} ) + S {3}_{WL} \qquad ( 9 )$$

The continuous current I which is expected to pass through the windings for the given input voltage V at the required power output P is given by the equation:

$$I = \frac{P}{V} \qquad ( 10 )$$

An appropriate gauge of wire is selected based on current I having diameter C. Packing factor pf is the maximum area of cross sections of the wire which can fit per unit of area. This depends on the cross sectional profile of the wire.

The number of turns on stator cores of type 1, 2 and 3 (refer FIG. 8), S1_{N}, S2_{N} and S3_{N} respectively, can be determined using the following equations:

$$S {1}_{N} = S {1}_{WL} \times S {1}_{WH} \times \frac{4}{π \times {C}^{2}} \times pf \qquad ( 11 )$$

$$S {2}_{N} = S {2}_{WL} \times S {2}_{WH} \times \frac{4}{π \times {C}^{2}} \times pf \qquad ( 12 )$$

$$S {3}_{N} = S {3}_{WL} \times S {3}_{WH} \times \frac{4}{π \times {C}^{2}} \times pf \qquad ( 13 )$$

The flux density of magnetic circuits of the motor are maximized in order to increase the power density of the motor. For a 3 phase motor/generator design as shown in FIG. 1 and FIG. 7, with a set of 6 stator cores consisting of two stator cores of each type (refer FIG. 8), two types of magnetic circuits can be formed—MC₁, formed by one type 1 and one type 3 stator core, and MC₂, formed by the two type 2 stator cores. Hence the magnetic circuit of two phases of the motor will be of type MC₁, and one phase will be of type MC₂.

The following equations can be used to determine the flux density of the magnetic circuits where Mc is the permeability of the core material, μₒ is the permeability of air, and ag is the air gap or clearance between the stator and rotor:

$$M {C}_{1} = \frac{( S {1}_{N} + S {3}_{N} ) \times I}{( \frac{S {1}_{CL} + S {3}_{CL} + π \times R}{{μ}_{c}} + \frac{4 \times a g}{{μ}_{o}} )} \qquad ( 14 )$$

$$M {C}_{2} = \frac{2 \times S {2}_{N} \times I}{( \frac{2 + S {2}_{CL} + π \times R}{{μ}_{c}} + \frac{4 \times a g}{{μ}_{o}} )} \qquad ( 15 )$$

### Objective Function

$$Maximize : \frac{min ( M {C}_{1} , M {C}_{2} )}{S {1}_{CL} + S {2}_{CL} + S {3}_{CL}} \qquad ( 16 )$$

### Subject to Constraints:

1. Maximum Flux Density of Magnetic Circuit
   MC₁≤S
   MC₂≤S
2. Maximum Bend Angle
   x≤45
   y≤15
3. Maximum Stator Core Thickness

$$T \leq 2 \times R \times sin ( \frac{360}{2 \times 12} )$$

4. Balancing Turns across Stator Types
   Balancing Factor bf determines how closely the number of turns on a stator type needs to be matched to the number of turns on the other two stator types. It ranges from 0 to 1, 1 requiring perfect balance, i.e. all stators must have the same number of turns.

$$S {1}_{WL} \times S {1}_{WH} \geq max ( ( S {1}_{WL} \times S {1}_{WH} ) , ( S {2}_{WL} \times S {2}_{WH} ) , ( S {3}_{WL} \times S {3}_{WH} ) ) \times bf$$

$$S {2}_{WL} \times S {3}_{WH} \geq max ( ( S {1}_{WL} \times S {1}_{WH} ) , ( S {2}_{WL} \times S {2}_{WH} ) , ( S {3}_{WL} \times S {3}_{WH} ) ) \times bf$$

$$S {3}_{WL} \times S {3}_{WH} \geq max ( ( S {1}_{WL} \times S {1}_{WH} ) , ( S {2}_{WL} \times S {2}_{WH} ) , ( S {3}_{WL} \times S {3}_{WH} ) ) \times bf$$

5. Non Negative Constraint
   L, R₁, R₂, R₃, MC₁, MC₂, x, y, T≥0

1. A multi rotor radial flux arch stator motor comprising:
a plurality of rotors;
a plurality of stators;
a plurality of stator windings;
wherein said plurality of stators positioned in between every two of said plurality of rotors that are adjacent to each other;
wherein each of said plurality of stators comprises a stator core having two stator poles and a stator winding with each of said stator winding and stator core being individual parts in the motor assembly;
wherein, said stator windings are wound around said stator cores, occupying a space in between said rotors and spaced away from the rotors;
wherein, each of said stator cores of said plurality of stators extends from a curved surface of one rotor of said plurality of rotors to a curved surface of an adjacent rotor, with each end of each of said stator core functioning as a stator pole to two adjacent said rotors of said motor;
wherein, said stator poles of said stator cores cover one half of an inner circumference of each of said two adjacent rotors;
wherein each end of each stator core act as magnetic poles around said rotor enabling a flux at both ends of said stator core to be converted to torque efficiently;
wherein, said plurality of stator cores are grouped into one or more electrical phases and arranged sequentially around the rotors based on the number of phases;
wherein, said stator poles of said plurality of stator cores of said electrical phases are magnetized by said stator windings when said electrical phases are energized, producing a magnetic field; and
wherein, said magnetic field interacts with said rotors at each end of said stator cores.

2. The motor of claim 1 wherein a design of the plurality of stators enables higher flux density at a face of the stator poles up to a saturation point of a stator core material due to a uniform cross-sectional area of the stator core both at a stator pole face and at the stator windings.

3. The motor of claim 1 wherein a negligible gap between the stator poles lowers torque ripple in synchronous applications.

4. The motor of claim 1 wherein a position of the stator windings spaced away from the rotors enables cooling of the windings by liquid immersion.

5. The motor of claim 1 wherein the position of the stator windings spaced away from the rotors enables cooling of the windings by air cooling.

6. The motor of claim 1 wherein, the stator cores are constructed from laminate material having high permeability to direct a magnetic flux produced by the stator windings radially towards the rotors through the stator poles, with said laminate material oriented in a plane perpendicular to an axis of rotation of the rotors.

7. The motor of claim 6 wherein the laminate material that make up the stator cores are oriented such that the long edges of the laminate material at a stator pole face are parallel to an axis of rotation of the rotor.

8. The motor of claim 1 comprising a mechanical linkage linking the plurality of rotors such that the direction of rotation of the adjacent rotors are opposite to each other, with a magnitude of angular velocity and degree of rotation equal for all rotors, keeping the plurality of rotors in sync to rotate at equal rotational velocity.

9. The motor of claim 8 wherein, the mechanical linkage transmits torque between the rotors when load at each rotor is not equal.

10. The motor of claim 8 wherein, torque ripple produced by the motor is reduced due to a negligible gap between stator poles and an increased moment of inertia created by a plurality of rotating rotors and the mechanical linkage.

11. The motor of claim 8 comprising a clutch mechanism along with the mechanical linkage to provide the added capability of selectively engaging and disengaging the mechanical linkage between the rotors.

12. The motor of claim 8 wherein the mechanical linkage is engaged using the clutch mechanism to transmit power directly from the external mechanical power source to drive the loads at the rotors, bypassing the motor.

13. wherein one or more rotors are driven as a generator by an external mechanical power source while the remaining rotors drive loads as a motor in conjunction with an electrical power source creating an excitation field to enable power generation from said mechanical power source.

14. The motor of claim 13 wherein the mechanical linkage is disengaged using the clutch mechanism and the rotors drive loads as a motor in conjunction with the electrical power source to supplement the mechanical power source when the power requirement exceeds the power available from the mechanical power source.

15. The motor of claim 13 wherein when the mechanical linkage is disengaged using the clutch mechanism some rotors are driven by the external mechanical power source and other rotors driven by the electrical power source.

16. The motor of claim 8 wherein, the motor is a synchronous motor and consists of one position sensor mounted on a rotating component of the mechanical linkage to sense the position of the rotors.

17. The motor of claim 8 wherein, the motor is an asynchronous motor.

18. The motor of claim 8 wherein the motor is an alternating current induction motor.

19. The motor of claim 8 wherein the motor is a permanent magnet brushless direct current motor.

20. The motor of claim 8 wherein the motor is a switched reluctance motor.
